(19) United States
(12) Patent Application Publication
(10) Pub. No.: US 2026/0114382 A1
(43) Pub. Date: Apr. 30, 2026

(54) DEVICE FOR CULTIVATING AND FOR PROTECTING FOREST AND/OR CROP PLANTS, USE OF THE DEVICE, AND METHOD FOR PRODUCING THE DEVICE FOR CULTIVATING AND FOR PROTECTING FOREST AND/OR CROP PLANTS

(71) Applicant: Johannes Wagner, Stopfenheim (DE)

(72) Inventors: Johannes Wagner, Stopfenheim (DE); Ulrich Grauvogel, Nürnberg (DE)

(21) Appl. No.: 18/270,527

(22) PCT Filed: Dec. 31, 2021
(86) PCT No.: PCT/EP2021/087899

§ 371 Date: Oct. 13, 2023

(30) Foreign Application Priority Data
Jan. 5, 2021 (DE) 10 2021 100 066.1

(51) Int. Cl. A01G 9/029; A01G 13/28

(52) U.S. Cl. CPC A01G 9/0291; A01G 13/28

(57) ABSTRACT

The invention relates to a device (1) for cultivating and for protecting forest and/or crop plants comprising a protective structure (5) for protecting forest and/or crop plants from damage, a substrate loaded into the protective structure (5) on/in which at least one seed for a forest and/or crop plant can be placed/inserted to cultivate a seedling therein, and is characterized in that the protective structure (5) is provided closed at one end in order to hold and store the substrate (3). The invention further relates to a planting device for cultivating and for protecting forest and/or crop plants. The invention also relates to a method for cultivating and for protecting forest and/or crop plants by means of such a device (1), and to the use of the device.

The invention relates to a device for cultivating and protecting forest and/or crop plants according to the preamble of claim 1. The invention also relates to the use the device for cultivating and planting forest and/or crop plants, a planting device, and a method for producing the device for cultivating and planting forest and/or crop plants.

### PRIOR ART

Planting sleeves and browsing protection devices are known in various designs, especially from forestry and forest management. Browsing protection devices may be mechanical, such as fencing around one or more individual trees or entire crops. Furthermore, it is known to use, for example, wire mesh or grids for single tree protection, especially in combination with wooden slats, posts, etc.

Planting sleeves are also known, especially in viticulture and horticulture, as protection against natural forces such as hail, storms and heavy rain, or even game browsing.

In addition, for example, purely chemical or biological browsing protection agents such as Certosan are for direct application to an ornamental crop or forest plant.

For example, such browsing protection agents are either painted or sprayed on or applied as natural sheep wool, especially on the main and leading shoots, so that game is deterred. Also provided, for example, are browsing protection caps for year-round mechanical terminal shoot protection, made, for example, of a flexible UV-stabilized polyethylene or PE fabrics, which are intended to remain on a plant year-round. Disadvantageously, such browsing protection caps have to be placed individually on planted trees or young plants and may fall off, for example, due to weather or other damage, which is why they have to be replaced.

In addition, it is also known to subsequently align metal grid structures in a wide variety of designs, for example as metal grid sleeves, around planted seedlings.

Disadvantageously, known browsing protection devices are costly to produce and to deploy. They also usually have to be dismantled, which in turn incurs man-hours and thus additional costs.

Furthermore, it is known to grow bare-root/undercut forest and crop plants, especially in nurseries. In this process, the seeds are planted in seedbeds, and the plants to be grown remain in the nursery for about 2 to 3 years. The roots of bare-root plants are pruned when they are removed from planting beds, and before they are transferred to containers, which can lead to root degradation. This can often lead to high plant failures when planting out in the forest, for example. The loss here can be up to 50 percent or more.

In general, the cultivation or growing method for forest plants distinguishes between bare-root plants and the cultivation into balled plants. Bare-root plants are usually used for forestation in the lowlands. However, on difficult sites, balled plants are most often used. In particular, the focus is on protection forest management and forestation, especially in mountainous areas. Balled plants are completely surrounded by a ball of earth around the roots.

In particular, firs as taproots or maples or even other deciduous hardwoods are pruned, which can lead to a reduction in the growth rate. This is called planting shock when the nursery stock is spread in the forest and planted. This can lead to the shrinkage or non-growth of the respective plantlet or seedling.

In addition, various planting methods and cultivation methods are known from nurseries, where, for example, a so-called quick pot or a “Hokoplast” or “Liechtensteiner container” is used for cultivation. However, there is usually too little soil for this in the container for free root development.

In forestry, perennial container plants are commonly used for forestation of damaged areas, especially in high mountain areas in protection forests. On the one hand, these enable a flexible and no less time-critical way of working and are also said to have higher cultivation successes in some cases. A disadvantage is a perennial cultivation or growing in a nursery associated with high costs. Also, current perennial plantings available do not meet current needs.

From DE 10 2009 003 164 B4 a planting sleeve for the protection of crop plants during their growth phase with a wall of at least one wall material and a lumen is known, in which the planting sleeve has biostatic and/or biocidal properties due to its physical properties and/or its chemical design or features.

DE 195 48 707 A1 discloses a method for producing an object of utility from an at least substantially biodegradable and/or compostable material. In principle, this is a cultivation pot or flower pot made of a biodegradable material.

US 2008/0078117 A 1 discloses a method of incorporating crop plants or grown seedlings into a net intended to protect against game browsing. The raised plant is placed in a tube, and then an elastic net is put over it. The elastic net is open on both sides. The root ball and the net together also do not form a solid connection but are spaced apart. Only when planting will the soil stabilize the combination. Damage to the plant may occur when covering the net over the plantlet and placing the plantlet in the tube.

Finally, DE 10 2017 011 54 7. 8 of the applicant discloses a device for cultivating and protecting forest and/or crop plants, having a carrier unit which consists of a substrate and whose volume can be increased by fluid absorption, a protective structure which can be placed around the carrier unit. The dimensions of the carrier unit and the protective structure are adapted to each other such that in a dry initial state of the substrate, the protective structure can be placed detachably around the carrier unit, and after fluid absorption of the substrate, both are firmly connected to each other.

### OBJECT AND SOLUTION OF THE INVENTION

Against this background, it is the object of the invention to provide an alternative device for cultivating and protecting forest and/or crop plants which, in particular, has a simple design and is inexpensive to produce.

This object is solved here by each of the subject matter of the independent claim 1 and of the subordinate claims 11, 13 and 15.

Thus, the device for cultivating and protecting forest and/or crop plants mentioned at the outset has the following additional features: the protective structure is provided closed at one end for receiving and storing the substrate.

This device according to the invention is also referred to as the new “Altmühltal plant pot”.

The subject matter of claim 11 is characterized by a planting device for planting a device for cultivating and protecting forest and/or crop plants.

This planting device according to the invention is also referred to as the “Altmühltal hole punch”.

The method of claim 13 for producing a device for cultivating and protecting forest and/or crop plants is characterized by the following steps:
1. Placing the protective structure on a tube,
2. Filling substrate into a hollow cylinder,
3. Inserting the hollow cylinder into the tube, wherein the protective structure is pulled into the tube as well,
4. Introducing and/or compacting the substrate by means of a plunger that can be placed in the hollow cylinder,
5. Removal of the plant pot from the tube or removal of the tube and the plunger from the plant pot, and
6. Placing/inserting a seed of a crop and/or forest plant on or in the substrate.

This planting method according to the invention is also referred to as the “Altmühltal planting method.”

Placing or inserting a seed of a crop and/or forest plant on or into the substrate may be done subsequently or beforehand.

The subject matter of claim 15 is characterized by the use of a device for cultivating, protecting, and planting forest and/or crop plants according to the invention.

Basically, the protective structures or nets can be designed in any suitable dimensions, in particular in terms of length and diameter, depending on the customer's specifications. Especially for seedlings and plantlets, the average length between 20 and 40 cm, especially 30 cm, has proven to be suitable. Advantageously, production is inexpensive, especially since cutting to length can be accomplished by simple means if the dimensions are suitable.

Any suitable substrate materials or soils can be used for the substrate. The substrate material may comprise, for example, soil, compost, peat and/or also coconut fibers and/or mixtures thereof. The substrate material serves as a water and air reservoir and facilitates accelerated growth of young plants in the planting year. Substrate mixtures that, in particular, do not contain lime, resulting in a low PH, are well suited for the propagation of various tree species.

Various substances can also be added to the respective substrates, for example volcanic soil, for improved water retention, peat, etc. The substrate can be mixed appropriately with simple mechanical means before filling. Likewise, if desired, substrate from the particular place of planting can also be used.

The loose substrate advantageously has sufficient air and water permeability and thus aeration, which favors root growth. Within a short time, this leads to good, and, in particular, uniform rooting of the substrate material, which is favored in particular by so-called “air pruning”. In this process, fine roots emerging from the substrate material die off in the air, resulting in improved root volume or rooting inside the substrate body.

A high pore volume and the resulting drainage properties allow unproblematic irrigation of the roots. Overall, stable, and high-quality trees with a high individual tree stability can be produced. This is a significant difference from the bare-root/particularly undercut nursery stock presented, which often suffers and dies in plant shock after placement.

The device according to the invention allows the formation of a natural root system, which also improves seedling cultivation and, in particular, reduces the risk of planting shock when the plant is later distributed, especially in the forest. Undisturbed root growth is the most important point for the stability and vitality of a growing tree. Later repotting can be avoided. The composition of the substrate also determines the air proportion, which can be up to 30%. The plant pot is 100% compostable and approved for use in organic farming.

Also, such seedlings can be released into the wild early, and since they require only a short period of time in the nursery, especially a period of half a year to a year, which further reduces costs. Advantageously, these plants are available within one growing season, which is why damaged areas become less or only slightly grassy. Also, a certain selection can be made already in the nursery, so that only well-developed seedlings are sold. Overall, this allows one to achieve a low and cost-effective price for the product and, of course, the subsequent planting.

Advantageously, the method according to the invention can be used to provide an “Altmühltal plant pot” or pot. Placement of the seed is possible by hand or machine and, incidentally, easy to handle. This allows for a significant reduction in the production price or cost, especially for rarer tree species, such as sweet chestnut or black walnut, including potted species such as oak in various species. It goes without saying that seeds are used that are true to their origin.

In addition, the transport costs of the respective finished plant pots can be reduced, since, for example, the individual pots can be bundled with strings at the top. This has particular advantages when planting in mountainous or rough terrain.

Overall, the production of plant pots is many times more effective and economical compared to previous variants. After filling the substrate and populating it with seeds, the net or protective structure can be pulled up by simple means to finish the transport in the last step.

The protective structure can have suitable geometric configurations and dimensions; for example, it can have a sleeve-like, cylindrical, angular, rectangular, oval, conical, or even cuboid shape. The determining factors are the dimensions of the substrate and a complementary design of the protective structure. Preferably, the protective structure is a cylindrical or sleeve-like configuration.

The protective structure can be configured in height as required, and can be provided such that approximately one-third surrounds the substrate and two-thirds extends upward. It can be oriented to the expected growth length of a seedling within a period of two to three years if desired longer or shorter. The protective structure can enclose the substrate over its entire height/length or only partially. Advantageously, there are no limitations on the dimensions, especially not the height dimensions of the protective structure.

The protective structure protects the pot and the seedling when cultivating the seedling and especially when transporting the cultivated seedling, as well as the seedling planted out and, if suitably designed, also provides a marking option on the surface. In addition, the protective structure serves as a protection against game browsing or snails or micro rodents such as mice, etc.

The protective function, especially during transport, is particularly necessary in the field of forest plants and especially in the so-called protective forest rehabilitation and the spreading of forest plants on high mountain areas. For example, in high mountain operations, the grown seedlings are brought to the deployment or planting sites by helicopter and must be transported from there, sometimes by hand, in suitable carrying boxes to the planting site.

During planting, a good connection between the protective structure and the substrate is advantageous because the person planting, especially in the case of manual planting, can easily grasp the protective structure and insert the entire device into a prepared planting hole. The planting itself does not require any special prior knowledge, such as the application of bare-root plants. Overall, the cost of the plant (seedling) and planting can be significantly reduced, compared to conventional potted plants by about 40-50%, both in the lowlands and in the mountains. Also, the cost is lower compared to two-to three-year-old bare-root plants grown in nurseries, which have little chance of growing, especially in the mountains and mountain forests.

The protective structure can serve as a support for a mulch sheet, which during the cultivation phase of the seedling serves as a protection against accompanying vegetation, for the deterrence of rodents and grazing game, and as manure, provided that it is made of natural sheep wool or a natural material of similar characteristics.

The substrate material may consist proportionally of biochar. Substrate material with biochar content develops adaptively designed to seed and target environment, dosable depot effect for water and soil improvement. Biochar can also be quantity monitored as it is incorporated and provided with an end-use record that can be tracked using means of digitization such as coding.

The substrate material can be adaptively adapted to the target environment as a molded product or in the course of the filling process, for example to compensate for the acid characteristics in former monocultures to be converted, especially acidic coniferous forest soils.

The planting device can be provided as a mechanical or motor-manual planting device. In the case of a manual planting device, this can be provided as an “Altmühltal hole punch,” for example, with a handle and stem accordingly, so that a person can push it downwards into the soil. Such a configuration can be provided with simple means. In the case of a cylindrical carrier unit, the complementary section is also cylindrical.

For example, a stop element can be produced in various suitable geometries. In particular, this is provided as a plate-shaped stop element, preferably with a diameter of 15 to 25 cm, particularly preferably of 20 cm. The plate-shaped stop element is then held up on the surface of the soil when the planting device is pushed into it, so that the depth of penetration of the cylinder section or section displacing the soil is limited.

The device for cultivating and protecting forest and/or crop plants may have an at least partially enclosed protective structure.

Preferably, the protective structure has openings over all or part of its surface.

The openings can be provided, for example, as notches, penetrations, round, oval or otherwise suitable openings with suitable geometries and dimensions. On the one hand, this advantageously realizes sufficient water and air supply, or circulation compared to closed protective sleeves. In addition, such a structure enables the previously outlined browsing protection function against wildlife and small rodents, snails, etc.

Preferably, the protective structure of the device comprises, in whole or in part, a grid mesh and/or honeycomb structure.

For example, the protective structure may be formed during the production. Its material can be delivered, for example, on a roll or as flat strips of about 20 cm or 30 cm in length and width. These are rolled up and joined together, for example glued, welded, or otherwise suitably fastened together to form the preferred sleeve-like structure described previously. The advantage here is a small space requirement when transporting the materials for the protective structure. Damage during transport of the protective structure is avoided as well.

The openings of the protective structure can have any suitable diameter. Preferably, the openings comprise a diameter of about 0.1 cm to 3 cm, preferably from 0.25 cm to about 2 cm, and most preferably in a range from about 0.5 cm to about 1 cm.

The latter dimensions have proven to be particularly suitable for slug repelling. Likewise, they sufficiently prevent wildlife or rodent browsing. This also ensures sufficient air and water circulation.

Preferably, all or part of the protective structure is provided with or comprises one or more chemical or biological or mechanical browsing protection agents.

In this context, browsing protection agents such as biocides, herbicides, fungicides, or rodenticides can be used with tested and approved commercially available protection agents, in particular browsing and browsing deterrent agents, for example sprayed on or painted on. Alternatively, and/or additionally, such materials or additives can also be incorporated and integrated during the production of the protective structure.

Alternatively, and/or additionally, mechanical browsing protection means such as commercially available single browsing protection means in the form of additional rods, grids, etc. may be coupled to or with the protective structure.

The protective structure may be provided in natural color, such as the color of the starting materials of the protective structure.

Preferably, the protective structure is provided wholly or partially with or comprises one or more color designs, in particular signal colors.

For this purpose, for example, color particles or color concentrates can be added to the material during the production of the protective structure. Such color particles and concentrates can be used, in particular, on a natural basis and, in particular, can also comprise biodegradable colors.

For example, different tree species can be marked with different colors in forestation using simple means. In particular, signal colors can improve detectability when the area is grazed, that is, when the grass growth is multi-sided and excessive. This reduces the risk of damage to the plants when cutting them free.

The protective structure may be produced from a non-biological material, for example plastics, such as a PE material, or metal grids. However, these are costly and have negative environmental impacts or need to be degraded.

Thus, the protective structure is preferably made of a biodegradable material.

This prevents later negative environmental influences. In particular, it can be a biodegradable material, especially according to compost standard DIN EN13432. For example, materials from the company Bio-Flex F2110 or Bio-Flex F6510 or Bio-Flex FX1821 or “Bionetting” 251.09.N35 or Plantagard or comparable materials are suitable. Bioflex materials are biodegradable and compostable plastic compound for the production of flat films and injection molded parts with high wall thickness from the company FKuR Kunststoff GmbH based in Willich. Such materials are biodegradable and decomposable without residue within a period of a few growing seasons, for example within one to two or three years.

Preferably, the device may include a securing means for securing the connection between the substrate and the protective structure.

This can be, for example, a ribbon-like structure, such as in the manner of a cable tie, etc., which additionally secures the connection. This measure ensures the firm connection, especially under rough transport conditions.

Preferably, the device for cultivating and protecting forest and/or crop plants may provide a support structure for securing the protective structure.

This can be, for example, a rod, a post, a slat, etc., which serve to stabilize and secure the protective structure. For this purpose, the support structure can be attached to the outside or inside the protective structure, for example, via opening(s), tabs, etc. provided in the protective structure. The support structure can additionally be inserted into the soil during planting.

Preferably, the substrate is at least partially surrounded by a holding structure, in particular a mesh structure.

This can be an elastic holding structure or net structure, in particular a biodegradable structure, especially according to DIN EN13432, for example paper, pulp or suitable bioplastics or other suitable biomaterials such as cotton. In particular, the net made of beech pulp is a natural product, so that plastic inserts can be avoided in the interest of sustainability.

The holding structure or net structure allows for transplanting without or with only reduced planting shock, as the substrate also does not fall apart, especially in the case of weak rooting. It also eliminates the need to pull pots or clean up plastic pots, etc. from the plant, making this an environmentally friendly alternative to traditionally used plastic containers. It also avoids releasing plastic waste into the environment.

Preferably, the stop element of the planting device is height-adjustable and/or the section is provided pointed and/or rounded at its end penetrating the soil.

Height adjustability can be provided, for example, by suitable known adjusting devices, such as clips, clamps, threaded sections etc. A pointed and/or rounded end facilitates penetration into the soil.

Advantageously, this allows for different planting depths or penetration depths of the planting device to be specified and for a planting device to be provided for different support units with protective structures or source pots with different heights.

Preferably, the method for producing a device for cultivating and protecting forest and/or crop plants comprises the following further steps:
Using a dibber or dome for compacting the substrate, wherein the dibber is provided on the plunger and/or
Transport of the device with seedling grown therein and/or
Planting the device, in particular, by means of a planting device according to claim 11 or 12.

Planting devices are commercially available in a variety of designs. For example, there are tubes with a hinged bottom attachment, which are inserted into the soil by a mechanical operation pushing aside or picking up the soil in the hole, so that the device with the pulled seedling can be dropped from the top of the tube into the planting hole. This also allows for planting by less trained personnel. For example, the following planting tools can be used: Pottiputki tube, hollow spade, Rhoden hoe. Alternatively, the Altmühltal hole punch (hole punch in the form of the planting device with depth limiter), as well as electric motor-driven earth drilling systems, such as the DRILLFast from Bast.-Ing. GmbH can be used. With the application of the latter possibility in particular, uniform cavities are always created in soils of any consistency, into which the planting cartridges according to the invention can be inserted without deformation. Then, all that remains to be done is to cover the joint gap against the incidence of light with material that naturally accumulates during the drilling process in order to activate the process of growing the completely undamaged root house.

Advantageously, no special expertise is required for planting, but this is different for bare-root plants, where planting errors can lead to death already during planting. Due to the well-developed fine root system, these plants are advantageously also plantable throughout the year.

This planting method is particularly suitable for planting in heavily weedy areas, for example, pine stands. If the ground is overgrown, natural regeneration is not possible and the introduction of bare-root plants is almost impossible due to weediness.

Here, the planting method according to the invention (Altmühltal planting method) can be used with the Altmühltal plant pot according to the invention. In particular, strips can be initially milled between the rows of trees, which makes the subsequent excavation of soil holes ergonomic and also cost-effective due to the speed of planting. In particular, the two-man method can prove advantageous, in which a first person uses the Altmühltal hole punch to force or form corresponding holes in the bottom of the milled strip at a predetermined distance, and the second person subsequently inserts the Altmühltal plant pots into these holes. This allows for increased planting performance at low planting costs.

Here, too, the protective structure protects the plants and makes them easily visible, so that even in the milled strip the plants can be found more easily. In this case, it is initially possible to wait and see which plants actually grow, in order to supplement any further browsing protection measures that may follow.

For a certain period of time, the combination of the protective structure and carrier unit can be stored without water, as the soil or pot is part of a natural water reservoir.

Preferably, the device for cultivating and protecting forest and/or crop plants comprises a support structure for stabilizing, holding and/or storing the device.

The device for cultivating and protecting forest and/or crop plants can be grasped by means of the support structure, for example, in such a way that the device can be manipulated manually, mechanized, or automated without touching and potentially deforming the root body.

For this purpose, the first support structure can be designed in a simple embodiment, in particular in the form of a plate or flange. In the form of a flanged mimic, it can grasp or encompass the device for cultivating and protecting forest and/or crop plants, for example by suitable coupling, e.g., anchoring at corresponding intersections.

The flanged mimic can be designed in a reverse open shape, so that the production of a single planar part in a single production step is sufficient to obtain a stable closed shape after fitting. This fixes the protective structure in the correct position during and after its filling with substrate and seedling, as well as during the entire subsequent pre-growing process under the influence of humidification and temperature.

Preferably, the support structure comprises intersections for coupling with the device for cultivating and protecting forest and/or crop plants.

With this measure, the individual elements can be securely assembled and/or fixed with structurally simple means.

Preferably, the support structure comprises intersections for prearranging the device for cultivating and protecting forest and/or crop plants.

With this measure, the devices for cultivating and protecting forest and/or crop plants can be aligned with simple means even before planting, which in particular facilitates mechanical deployment or planting. The support structure is not only advantageous as an axial depth reference for planting, but, if additionally indexed, can be used for automated handling and indication of preferred growth directions.

This also results in the possibility of “northing” the plantlets according to the boundary conditions that are considered locally advantageous.

Preferably, the support structure comprises an index mimic for rearranging and/or tailoring for deployment of the device for cultivating and protecting forest and/or crop plants. The index mimic also serves to keep the device for cultivating and protecting forest and/or crop plants in the correct position without being placed under its own weight on the bottom of the protective structure.

In this case, the force flow extends from the device for cultivating and protecting forest and/or crop plants into the flange plate or flange mimic or support structure in which the protective structure or net or grid is enclosed. This is particularly the case in combination of the previously described first support structure in conjunction with the second support structure described below. Thus, the root house created in the planting cartridge during pre-growth is not subject to compressive or squeezing deformation at any later time, not even axially under its own weight.

The support structure is also advantageous for the planting process itself. It also enables force-guided placement of prefabricated planting holes, such as cylindrical holes in the mineral horizon, produced by means of a Drillfast earth drilling system. The advantage here is that a hole does not have to be drilled with a large amount of play in order to insert the planting cartridges, which are subject to shape and dimensional tolerances, without deformation.

Rather, the invention now makes it possible to perform a joining operation by applying axial force to the upper end of the support structure, even under frictional force and locking action opposing the direction of action, and in such a way that the device for cultivating and protecting forest and/or crop plants or planting cartridge and the root house of the seedling housed therein are not deformed. The reason for this is the joining force transmission into the bottom of the device for cultivating and protecting forest and/or crop plants or the planting cartridge, so that the joining process always advantageously stretches the planting cartridge and does not disadvantageously compress it. This is particularly the case in combination of the previously described first support structure in conjunction with the second support structure described below.

The invention now also prevents the hitherto widespread and damaging practice of exerting an axial or even multi-axial force on the stem run and root house via the stem of the scion during the planting process. In the worst case, which has often been encountered until now, for example, a circumferential torsional bending load is introduced into the stem cross-section at ground level, with the effect of delamination of the fibers of the young stem known from the field of fracture mechanics.

To avoid the latter damaging effect, previous planting methods also relied on planting perennial seedlings that already have a woodier, and thus mechanically more stable, young stem. This, in turn, is contrary to the goal of an optimally designed cultivation phase, according to which a seedling must be delivered to its final location as young as possible and without schooling, in order to keep the extent and frequency of cultivation shock as low as possible.

The invention now makes it possible to deliver a seedling in its planting cartridge to its planting site just a few weeks after germination and at a time appropriate to the species, without manipulating its stem.

Preferably, the support structure comprises a data matrix code for identifying and locating the device for cultivating and protecting forest and/or crop plants.

Advantageously, a data matrix code is machine-readable during the process and clearly assigns the seedling's history of origin. The coding is used for proof of origin and end-use of the respective seedling and can be recorded and evaluated by means of interoperable web portals and mobile apps, especially on smartphones. Last but not least, the support structure, for example in the form of a flange plate, is also a carrier for placing a data matrix code, which is applied automatically during filling of the substrate material. Additional elements, such as seed and application geo-information, can thus be assigned to this primary key.

The data matrix code remains on the first support structure or flange mimic even after the seedling has been deployed with the device for cultivating and protecting forest and/or crop plants on the final retention area. The data matrix code can be captured using non-proprietary means of image recognition and persistently recorded in overarching database systems. For example, by means of mobile devices such as cell phones equipped with a corresponding app. In a simple embodiment, the data matrix code may be provided as a QR code, bar code, or otherwise suitable. After a single acquisition of an application process, the same data matrix code is advantageously not applicable a second time. It is virtually rotten, just as it becomes physically unusable after the support material of the first support structure or flange mimic has rotted.

Preferably, the device for cultivating and protecting forest and/or crop plants comprises a second support structure for coupling to the first support structure for stabilizing, holding, positioning and/or supporting the device of the device for cultivating and protecting forest and/or crop plants.

The plant cartridge body or device for cultivating and protecting forest and/or crop plants may be provided with the second support structure inside or outside the net for demanding pre-growing and deployment situations. The second support structure can also be provided without the first support structure.

In particular, the second support structure can be designed as a support body in the form of a framework. The second support structure or the support body can be of one-piece or of multi-piece design. For example, the second support structure or the support body can be formed from two reversed, essentially U-shaped stamped parts which can be connected as coupling points with a spatial 90°-swivel in positioning aids predetermined for this purpose. In a simple embodiment, support bodies can be plugged or inserted into positioning and coupling intersection, for example. In the coupled state, support elements form the spatial support body.

Stabilization of the second support structure or the support body can take place on the device for cultivating and protecting forest and/or crop plants, for example, on the protective structure or the net or grid structure, and/or via a coupling, for example, via latching with the first support structure or flange mimic. For example, intersections for hooking, such as recesses, can be positively engaged with intersections known for fixing the protective structure or the net, e.g., in the form of lugs. Any other suitable coupling is also possible, e.g., via snap, latch, tongue/groove click connections.

The second support structure or support body may be inserted inside the device for cultivating and protecting forest and/or crop plants, or it may surround the device from the outside. Preferably, the second support structure or support body stabilizes the device for cultivating and protecting forest and/or crop plants as an insert.

If a commercially available individual browsing guard is also to be provided on the device for cultivating and protecting forest and/or crop plants, a problem regularly arises from the fact that a force fit between the guard and the ground level must be produced at separate expense and then also geometrically aligned on the seedling.

Preferably, therefore, the second support structure comprises intersection geometry elements for coupling with additional browsing protection means.

The intersection geometry elements may be provided on the first and/or second support structure. For this purpose, any suitable intersection geometry elements can be provided, e.g., in the form of latching, snap, tongue-and-groove joints, etc. In a simple embodiment, vertical extensions of the first or second support structure can, for example, have the intersection geometry elements, e.g., in the form of openings, penetrations, recesses, cut-outs, etc. Browsing protection devices can then be referenced geometrically precisely and powerfully advantageously to the plant cartridge or the device, more precisely in or on the first and/or second support structure, by means of inexpensive round timber elements, for example.

Preferably, the second support structure also or alternatively comprises a data matrix code for identifying and locating the device for cultivating and protecting forest and/or crop plants.

Advantageously, a data matrix code is machine-readable during the process and clearly assigns the seedling's history of origin. The data matrix code remains on the first support structure or flange mimic even after the seedling has been deployed with the device for cultivating and protecting forest and/or crop plants on the final retention area. The data matrix code can be captured using non-proprietary means of image recognition and persistently recorded in overarching database systems. For example, by means of mobile devices such as cell phones equipped with a corresponding app. In a simple embodiment, the data matrix code may be provided as a QR code, bar code, or otherwise suitable. After a single acquisition of an application process, the same data matrix code is advantageously not applicable a second time. It is virtually rotted, just as it becomes physically unusable after the support material of the first support structure or flange mimic has rotted.

The first support structure or flange mimic or flange element as well as the second support structure and or its support body can be made of any suitable materials. Solid cardboard, corrugated cardboard structures and various types of wood or even biochar decompose within determinable periods of time suitable for the use of the device, depending on the composition and thickness of the material. Therefore, at the end of the cultivation phase of planting, no residues remain.

Besides wood or wood foil, the protective structure, but also the first support structure and/or the second support structure can be used from beside wood foil or cardboard just as well from bare steel foil as an option, which can be determined by the customer. With the help of the stretching technique, it is possible—within limits—to produce deep-drawn bodies from any slotted flat material, e.g., as expanded metal. Such “preforms” can, for example, be deep-drawn on the production machine itself before filling.

Preforms of this type are preferably produced flat from inexpensive semifinished film, sheet, or plate. The outer contour of the preform is mold-bound and can thus be mapped in one and the same production step, like other auxiliary mimics. An auxiliary mimic here is that a flange plate already created in the preform has holes, latching lugs, snap springs, into which the components of later growth protection elements can be adapted in a form-fit and force-fit manner.

Preferably, the first support structure and/or the second support structure of the device for cultivating and protecting forest and/or crop plants comprises or has fertilizing, catalyzing and/or mycological agents.

The design of the first support structure or flange mimic or flange element as well as the second support structure and or its support body opens up the possibility of using different types of wood for the individual elements with a mechanically equivalent effect. Decaying wood, for example, can thus be laid out and used specifically to fertilize and catalyze the seedling's interactions with its cultivation environment.

Agroforestry systems in particular regularly lack pre-forest ecosystem stages, such as symbiotic fungal systems. These can be formulated and applied in a site-adapted manner directly via the planting cartridge or device, without having to treat the site, for example, over a wide area prior to planting measures. Pre-aging of such structural elements can occur through natural exposure, as well as through saturation with excessive boundary conditions and inoculation of the first and/or second support structure with mother fungi. Thus, a depot effect can be developed during the cultivation and youth phase of the respective seedling.

Overall, in the device for cultivating and protecting forest and/or crop plants, the protective structure is also conceivable in all material variants.

In summary, the first and/or second support structure supplement the protective structure with components that have an advantageous effect on the pre-growing performance in terms of product, enable high repeatability in terms of process, and offer protection and traceability of previously unknown quality in the subsequent application.

The amount of plants to be produced in the course of combating the consequences of climate change must be increased not only by factors but by decimal powers, if only to maintain the plant population in the forest. In addition, creating resilience in rural areas and revitalizing already severely damaged stands and opening up regions of conservation will require more seedlings than simply reproducing known forest conditions.

In addition to traditional forestry applications, the device for cultivating and protecting forest and/or crop plants according to the invention can also be used in particular in agroforestry systems and in hitherto undeveloped regions of the world in terms of silviculture, in order to establish ecosystems there and to provide the plants required for this purpose in critical mass within a very short time.

These goals can be achieved by moving away from seasonal pre-cultivation to continuous production while maintaining the highest individual plant quality. In this way, failure rates in later use can be reduced to a fraction compared to traditional pre-cultivation and planting methods.

The device for cultivating and protecting forest and/or crop plants according to the invention can compensate for the climate impact unfolding in the course of its production, processing, application, and decomposition by incorporating biochar and can be designed to be at least climate neutral. The decomposition time of the fixture parts can be used as a reference period.

The aforementioned effects can also be set volumetrically to be targeted climate-positive if the balance over the reference period is carbon-negative. Separate applications for compensation purposes that take place elsewhere can take place intrinsically to the process in the device for cultivating and protecting forest and/or crop plants according to the invention. The device for cultivating and protecting forest and/or crop plants according to the invention is thus a reduction technology.

### DESCRIPTION OF THE FIGURES

Examples of embodiments of the invention are explained in more detail below with reference to the accompanying schematic drawings. The drawings show, in:

FIG. 1 a perspective illustration of a known protective structure in an oblique view from above;

FIG. 2 a perspective illustration of a protective structure according to the invention;

FIG. 3 a perspective illustration of the protective structure of FIG. 2 placed on a tube;

FIG. 4 shows a perspective illustration of a cylinder filled with substrate material;

FIG. 5 shows a perspective illustration of the cylinder of FIG. 4 filled with substrate material, which is partially inserted into the tube of FIG. 3,

FIG. 6 shows a perspective illustration of a ram for introducing and compacting the substrate material in the cylinder, into the tube of FIG. 3,

FIG. 7 shows a perspective illustration of a planting device,

FIG. 8 shows a planting device, the “Altmühltal hole punch”,

FIG. 9 shows a perspective illustration of a protective structure according to the invention with an additional first support structure;

FIG. 10 shows an enlarged detailed view of the support structure of FIGS. 9 and 11, viewed obliquely from above;

FIG. 11 shows another perspective illustration of the protective structure according to the invention with the additional support structure of FIG. 9, and

FIG. 12 shows a second support structure that can be coupled to the first support structure.

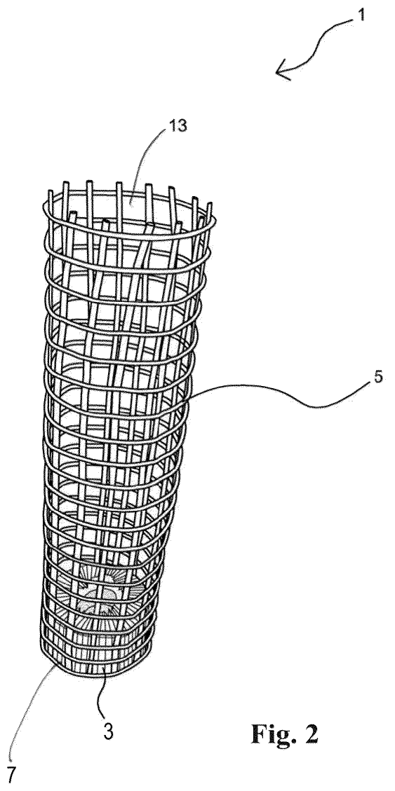

The structure and function of the device for cultivating and planting crop and forest plants 1 according to the invention are explained below with reference to FIGS. 2 to 7.

The same reference signs apply throughout to all figures.

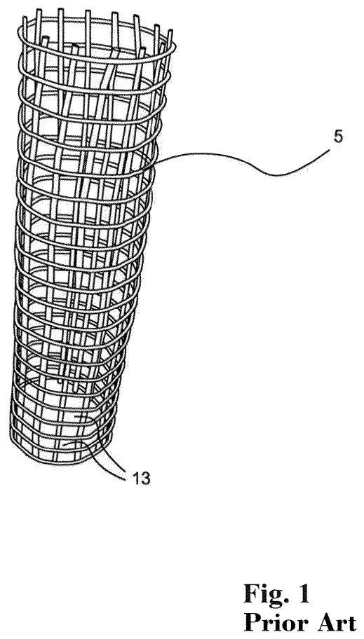

FIG. 1 shows a perspective illustration of a known protective structure 5 which is open at both ends and has a mesh structure or openings 13.

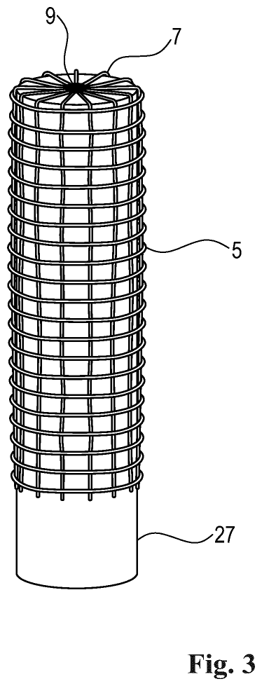

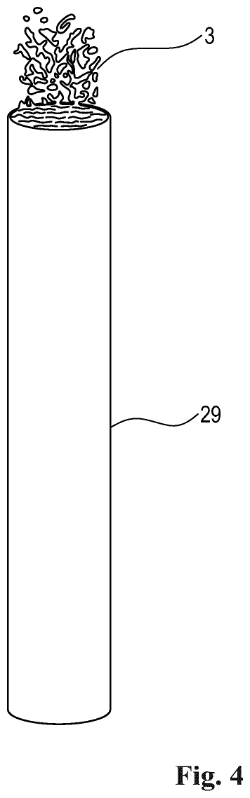

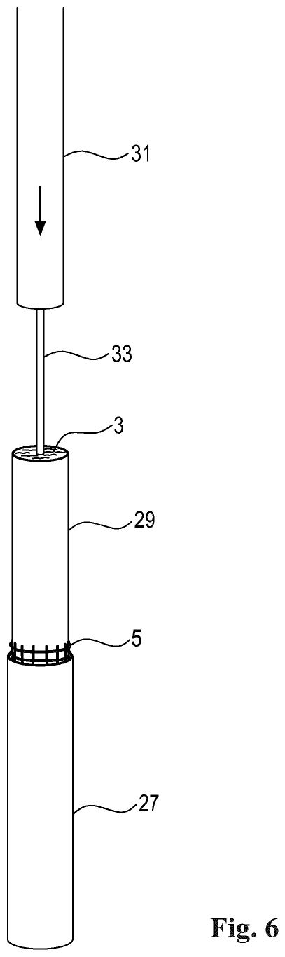

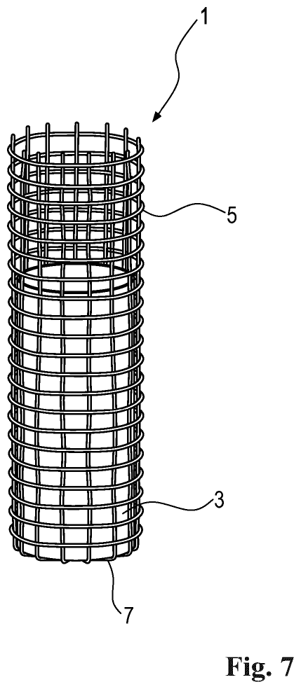

FIG. 2 shows a perspective illustration of a protective structure 5 according to the invention with a mesh structure or openings 13, which is placed on a tube 27 in FIG. 3. The bottom 7 of the protective structure 5 is closed, in the present case welded, for receiving and storing the substrate 3. In FIG. 4, a cylinder 29 filled with substrate material 3 is illustrated, which is placed on the tube 27 and partially inserted. By means of a plunger or plunger 31, the substrate material inside the cylinder 29 can be introduced into the tube of FIG. 3 and compacted, as shown in FIG. 6. FIG. 7 shows a perspective illustration of a finished planting device 1.

The substrate material 3 may consist of suitable planting substrates. The substrate material 3 is based on renewable resources and bio-based materials, such as soils of any kind, which can also be mixed in any way. Peat, coconut fiber, pulp, vegetable starch and other biomass can also be added. The substrate material 3 allows the formation of a stable root system, as root growth is not inhibited.

The protective structure 5 shown in FIG. 2 is designed as a grid structure with uniformly distributed meshes with a mesh width of approximately 0.5 to 1 cm. This mesh size is chosen so that, for example, snails or even wild animals have no possibility to damage the plants. However, other mesh sizes are also possible. Due to the mesh structure or openings 13, the protective structure 5 forms a so-called open pot wall, which is particularly important for the cultivation of trees, as this allows so-called “air-pruning” (a pruning of the roots by air) to be favored.

The material consists of a “biodegradable material according to DIN EN 13432. In the present case, the net in question is a net made by Breuers with the product name “Bionetting 251.09.N3 5”, which is welded and sealed on one side. For example, this material is also certified for home compost or similar. Depending on the thickness of the material, the degradation period may be one to two or three to four years, or in any case longer.

The protective structure 5 can be provided in a natural color shade or can have different colors; for this purpose, various natural-based color concentrates can be added during production, for example, which are also considered biodegradable.

A suitable width of the protective structure 5 in the flat state can be 20 cm, for example. For use in the device 1 according to the invention, the flat protective structure 5 is rolled up, and its ends are connected to each other in the longitudinal direction, for example glued or welded. In addition, the lower end of the protective structure 5 is closed, for example welded, or otherwise suitably connected. The protective structure 5 is cylindrical in shape. The dimensions of the protective structure 5, which is in the form of a sleeve, are approximately such that the substrate 3 can be inserted into the protective structure 5, where it can be compressed or compacted. A suitable length of the protective structure 5 can be 30 cm, for example. The protective structure 5 may also be provided with a biological or chemical deterrent.

The protective structure or net 5 in FIG. 3 is slipped over the tube 27. The end of the protective structure 5 is self-contained. The net length is about 20-30 cm. For example, the tube 27 comprises an inner diameter of 5.5 cm. Overall, however, all inside diameters and lengths are possible, depending on the respective product requirements.

FIG. 4 shows a hollow cylinder 29 completely or partially filled with a loose substrate (soil). This is an appropriately suitable soil material. In the present embodiment, the cylinder length is approximately 30 cm, and the outer diameter is approximately 5 cm.

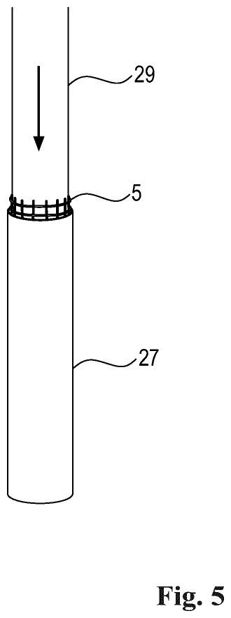

FIG. 5 now shows the third working step, in which the cylinder 29 filled with substrate 3 enters the tube 27 covered with the protective structure 5 as far as it will go, for example to a depth of 12 or 14 cm. As a result, the protective structure or net 5 between cylinder 29 and tube 27 is pulled inward into tube 27 together with cylinder 29.

A fourth work step is shown in FIG. 6. Here, a punch or plunger 31 is provided as a compression means. At its lower end, the punch 31 comprises a metal mandrel or dibber 33. The punch 31 may, for example, comprise dimensions in a diameter of 4.5 cm and the metal mandrel 33 may have a length of 12 cm.

The metal mandrel 33 is then inserted into the substrate material 3 in the direction of the given downward arrow, wherein the substrate material is inserted or pushed into the protective structure 5 and compacted accordingly.

In a fifth working step, the punch 31 with the mandrel 33 are accordingly removed from the substrate material. The substrate cylinder 29 and the tube 27 are removed as well.

The finished product shown in FIG. 7, the formed and netted plant pot, is also called the Altmühltal plant pot.

A plant or seedling grown in the protective structure 5 can be transported easily. After the seed has been placed or inserted, a suitable seedling, which is completely protected by the protective structure 5, grows in a period of about half a year to a year. This protection serves on the one hand during transport, for example in high mountain areas as well as in transport boxes, crates, etc.

A colored design, e.g. red, yellow or blue, of the mesh structure 5 makes it possible to find it quickly in the field, so that, in particular when weeding out, i.e. when removing or short-cutting the surrounding grass growth, after deployment of the device according to the invention in the field, unintentional cutting out or damage to the seedling can be avoided.

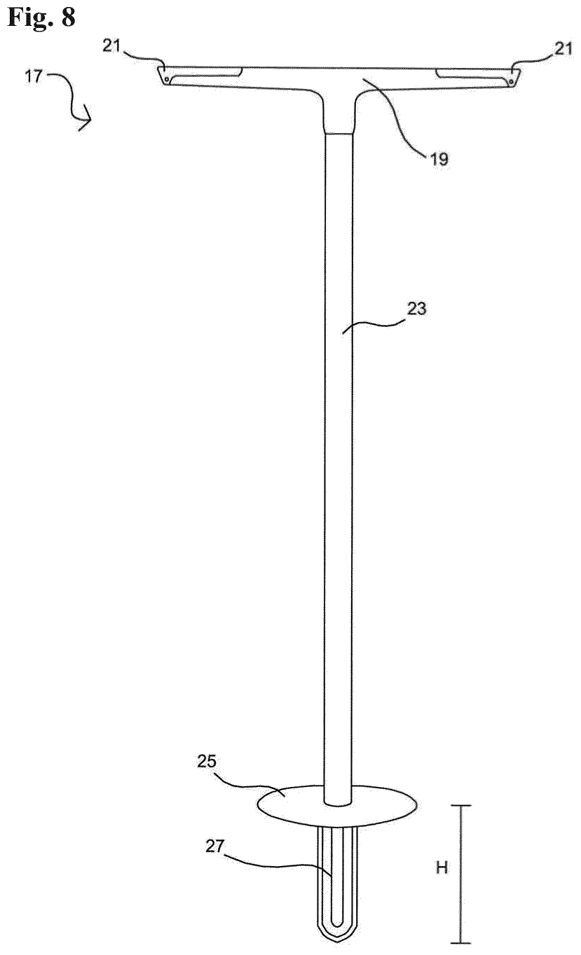

The planting device 17 shown in FIG. 8 is also referred to as the “Altmühltal hole punch”. It comprises a handle 19 with two actuating handles 21 formed laterally thereon. At about its center, a stem 23 extends downward to a stop element 25, which is designed as a stop plate. A diameter of the stop plate of 15 to 25 cm, preferably 20 cm, has proved to be suitable. The stop plate 25 serves as a stop for the hole punch and prevents it from penetrating too deeply into the ground.

Below the stop plate 25, a cylindrical section or cylinder 27 is provided having an outer diameter complementary to the device 1 for cultivating to protect forest and/or crop plants. At its lower end, the cylinder 27 is provided pointed or rounded. An outer diameter of 4.5 to 8 cm, preferably 5.5 cm, has proved particularly suitable. It corresponds approximately to the outer diameter of the device 1.

The cylinder section has a height H, which should correspond to the planting depth. It can be suitably selected and is approx. between 10 and 20 cm, preferably between 11 and 16 cm.

For planting, the Altmühltal hole punch 17 is forced vertically into the ground, allowing a hole to be formed in the soil (not shown) approximately equal to the outside diameter of the cylinder section 27. The hole punch 17 is then removed upwards, leaving a hole in the ground into which the device 1 for cultivating for the protection of forest and/or crop plants can be inserted.

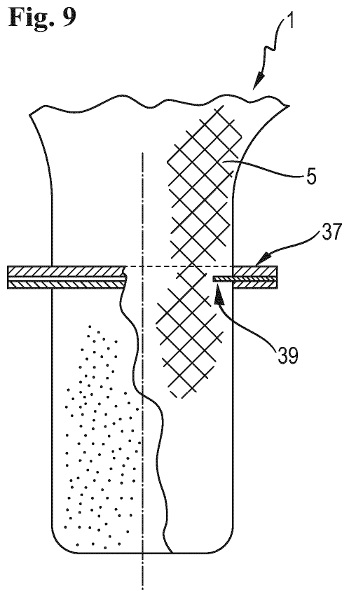

FIG. 9 shows a perspective illustration of a device 1 according to the invention for cultivating and transporting crop and forest plants, with a protective structure 5 enclosed by an additional first support structure 37.

The first support structure 37 is approximately plate-like with a flange mimic and surrounds the protective structure 5 at the height of an upper third. However, the support structure 37 may be positioned at any suitable height and according to any customer specifications.

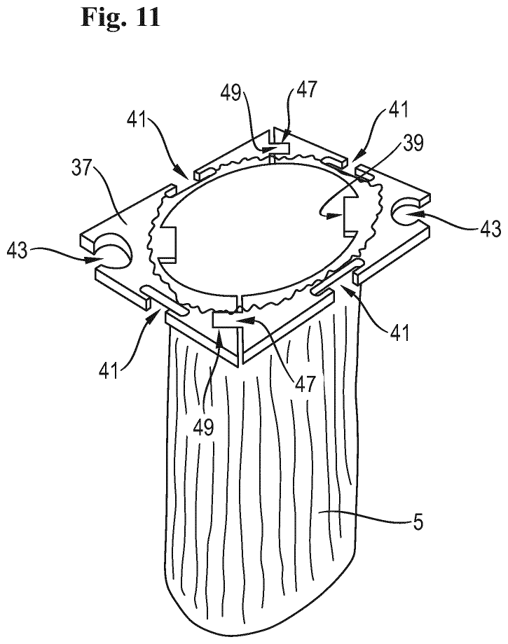

The support structure 37 comprises at least one intersection 39 for coupling with the protective structure 5 (cf. also FIG. 11). The intersection 39 may be provided as a suitable coupling means, for example, a detent, click, snap, or other suitable connecting means. In the present embodiment, the intersection 39 is configured as a protrusion or nose that engages with the protective structure 5. In the present case, the protrusion or nose is provided on two opposing inner sides of the support structure 37. It is equally possible to provide additional intersections 39 at further positions of the inner sides of the support structure 37.

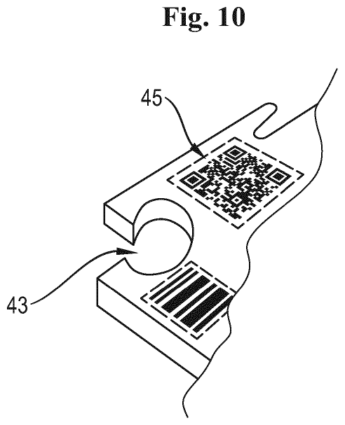

FIG. 10 shows an enlarged detailed view of the support structure 37 of FIGS. 9 and 11, viewed obliquely from above. A data matrix code 45 in the form of a QR code and/or bar codes is provided on the top of them. The data matrix code 45 may also be provided on all other sides of the support structure 37 or protective structure 5 or within the support structure 37 or protective structure 5, for example, as an RFID chip, transponder, or other suitable means.

The data matrix code is used to identify and locate the device for cultivating and protecting forest and/or crop plants. The data matrix code remains on the first support structure or flange mimic after the seedling is placed with the device 1 for cultivating and protecting forest and/or crop plants on the final retention area. For example, by means of mobile devices such as cell phones equipped with a corresponding app.

FIG. 11 shows another perspective illustration of the protective structure according to the invention with the additional support structure 37 of FIG. 9. The support structure 37 may be provided in one piece or in multiple pieces. In the embodiment shown here, the support structure 37 is provided in two parts. For this purpose, both sub-elements each comprise a coupling element 47 and a counter-coupling element 49, both of which are designed to be complementary to each other in the manner of an intersection. To connect the two partial elements, they are simply inserted or pushed into each other.

The support structure 37 further comprises an index mimic 43 for rearranging and/or tailoring for deployment of the device for cultivating and protecting forest and/or crop plants. The index mimic also serves to keep the device 1 for cultivating and protecting forest and/or crop plants in the correct position without being placed under its own weight on the bottom of the protective structure 5.

In addition, the support structure 37 comprises another intersection 41 provided in the manner of a recess or cavity for hooking. In the present embodiment, the hooking devices 41 are provided adaptively in time in 4×90° position adjustments, depending on the visual assessment of the root development of the uncovered protective structure 5.

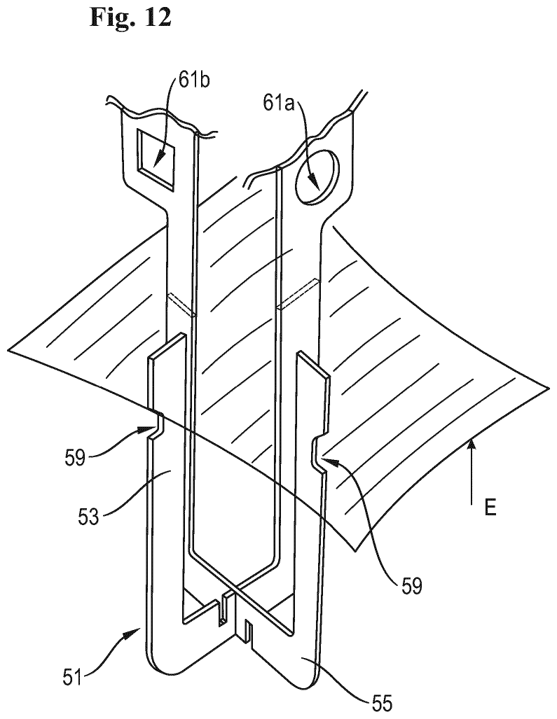

FIG. 12 shows a second support structure 51 that can be coupled to the first support structure 37 and that can be inserted into the protective structure 5. The second support structure 51 may be provided in one piece or in multiple pieces. In the embodiment shown here, it comprises a first support body 53 and a second support body 55. They are formed from two reversed, essentially U-shaped stampings. Under 90° spatial pivoting, the two support bodies 53, 55 can be inserted into predetermined intersections or positioning aids 57a,b to form the spatial second support structure 51.

In this embodiment, stabilization of the second support structure 51 on the device for cultivating and protecting forest and/or crop plants is accomplished via a detent in the first support structure 37 or flange mimic. For this purpose, coupling intersections 59 in the form of recesses are provided on the first support body 53 and on the second support body 55, respectively, which engage positively with the first support structure 37, in particular with the intersections or nose 39 of the first support structure 37.

Finally, reference sign E refers to the ground level as the boundary between the mineral horizon, in which the then invisible part is sunk, and the part of the planted device for planting and transporting cultivated and forest plants that remains visible after planting.

In the end, the second support structure 51 comprises intersection geometry elements 61a, b. These can be provided, for example, in the form of detents, snaps, tongue-and-groove connections, etc. In the present embodiment, vertical extensions of the second support structure have the intersection geometry elements in the form of openings, penetrations, recesses, cavities. In these, browsing protection devices can be referenced geometrically in or on the first and/or second support structure, for example, by means of round wood elements.

Further advantageous embodiments of the invention are apparent to the skilled person within the scope of the following patent claims.

### LIST OF REFERENCE SIGNS

1 Device for cultivating and transporting cultivated and forest plants/planting cartridge
3 Substrate
5 Protective structure
7 Soil
9 Connection/weld
13 Mesh opening/grid opening
17 Planting device
19 Handle
21 Actuating handle
23 Stem
25 Stop plate
27 Tube
29 Cylinder
31 Plunger
33 Dibber/mandrel
35 Punch
37 First support structure/flange mimic
39 Intersection/nose
41 Intersection/hooking device
43 Index mimic
45 Data matrix code
47 Coupling element
49 Counter coupling element
51 Second support structure
53 First support body
55 Second support body
57a,b Intersection/positioning aid
59 Coupling intersection with 39
61a,b Intersection geometry elements
E Ground level

1.-24. (canceled)

25. A device useful in the cultivating and protecting of forest and/or crop plants p grown in or on a substrate, the device comprising:
a substrate and a protective structure;
the substrate being a molded substrate extending along a length dimension, the molded substrate having an outer surface of a uniform, predetermined cross-sectional shape extending along the length of the molded substrate;
the protective structure comprising a flexible tubular body extendable along opposite first and second ends, the first end being a closed end of the tubular body, the second end being an open end of the tubular body;
the molded substrate being disposed inside the tubular body; and
the molded substrate and the tubular body being cooperatively sized wherein the tubular body is against and closely conforms with the outer surface of the substrate body.

26. The device of claim 25 consisting of the molded substrate and the protective member.

27. The device of claim 25 wherein the molded substrate has a circular cross-sectional shape.

28. The device of claim 25 wherein the tubular body is an open-mesh body or a biomesh body defining a plurality of through-openings extending through the tubular body.

29. The device of claim 25 wherein the tubular body is made of a biodegradable material.

30. The device of claim 25 comprising mechanical protection means and/or browsing protection means.

31. The device of claim 25 wherein the protective structure comprises chemical, biological, fertilizer, and/or mycological agents that assist a plant growing in the device.

32. The device of claim 25 comprising a plurality of through-openings extending through the tubular body.

33. The device of claim 5 wherein the molded substrate and at least a portion of the protective body surrounding the molded substrate is disposed in a first tubular member;
the tubular member comprising an internal wall surrounding the interior volume of the tubular member, the molded substrate and the tubular body being against the internal wall wherein the internal wall defines the cross-sectional shape of the molded substrate.

34. The device of claim 33 wherein the tubular member has a circular internal tubular wall.

35. The device of claim 33 comprising a second tubular member being partially inserted into the tubular body of the protective member and extending into the first tubular member, the second tubular member being at least partially filled with a substrate.

36. The device of claim 33 wherein the tubular body extends out from the first tubular member to the open end of the tubular member.

37. The device of claim 25 wherein the tubular body extends from the closed end first end beyond the molded substrate to the open second end.

38. The device of claim 25 wherein the tubular body comprises a coloring agent that visibly alters the color of the tubular body as compared to the color of the tubular body without the coloring agent.

39. The device of claim 25 wherein the protective structure comprises a first support structure surrounding the tubular body and connected to the tubular body, the first support structure being spaced away from the first end of the tubular body.

40. The device of claim 39 wherein the first support structure comprises one or more through-cavities disposed along an outer perimeter of the first support structure, each through-cavity of the one or more through-cavities enabling hooking of the first support structure.

41. The device of claim 39 wherein the first support structure comprises a plurality of outer sides surrounding the first support structure wherein adjacent pairs of the outer sides intersect at and define respective corners of the first support structure, and at least one corner of the first support structure comprises a slot open at the corner that is capable of receiving a separate additional support member into the slot.

42. The device of claim 39 wherein the first support structure is a flange-shaped member.

43. The device of claim 15 comprising a second support structure that receives and supports the closed end of the tubular body.

44. The device of claim 43 wherein first support structure is coupled to the second support structure by a mechanical coupling.

45. The device of claim 44 wherein the mechanical coupling is disposed to transfer a force applied to the first support structure urging the first support structure along the tubular body towards the closed end of the tubular body is transmitted from the first support structure to the second support structure through the mechanical coupling.

46. The device of claim 43 wherein the second support structure extends along the tubular body towards and beyond the first support structure, an upper end portion of the second support structure being disposed beyond the first support structure, the upper end portion of the second support structure being accessible for mounting browsing protection means thereto.

47. The device of claim 25 comprising a support structure that receives and supports the closed end of the tubular body.

48. The device of claim 25 comprising indicia that represents data associated with the device and/or a plant that will be grown in the device.
